(19) United States
(12) Patent Application Publication
(10) Pub. No.: US 2004/0135811 A1
(43) Pub. Date: Jul. 15, 2004

(54) Method and system for displaying data fields

(76) Inventors: Craig Pickering, Alpharetta, GA (US); Gregory D. Pickering, Atlanta, GA (US)

Correspondence Address: Gregory Scott Smith, P.O. Box 88148, Atlanta, GA, 30356, US

(21) Appl. No.: 10/341,792

(22) Filed: Jan. 14, 2003

(51) Int. Cl. G09G 5/00

(52) U.S. Cl. 345/777; 345/780

(57) ABSTRACT

A method for displaying data fields is described, illustrated and claimed. The present invention can be described as a novel system and method for displaying data fields in close proximity to accompanying label and summary information to facilitate ease of understanding and time efficiency. Label and summary information are fixed within a display window with accompanying data. The data can be scrolled or otherwise moved within the window for display while the label and summary information remain fixed to identify the associated data.

### TECHNICAL FIELD

The present invention relates to control interfaces for computer programs and, more particularly to a method for displaying tabulated data fields.

### BACKGROUND OF THE INVENTION

A database is one or more large structured sets of persistent data, usually associated with software to update and query the data. A simple database might be a single file containing many records, each of which contains the same set of fields where each field is a certain fixed width. A more complex database could contain thousands of files, each file containing thousands of records, with each record containing thousands of fields.

A record is an ordered set of fields, usually stored contiguously. In a database, a record is also called a “row” or a “column.” Each field within a record has a common identity to all fields in that record (e.g. a “total” record would be a record containing fields that exclusively contained totals therein).

Furthermore, a field is an area of a database record, or graphical user interface forms, into which a particular item of data is entered. Fields are presented to operators by way of a computer display or screen. A field in effect allows a user or operator to enter data into a database to be displayed by the computer.

Typically, databases can be viewed on a computer display through the use of tables. For example, in a WINDOWS operating environment, a window containing a tabulated listing of the table can be displayed. Windows are graphical interface components that present objects and actions to computer operators. Windows are presented to operators by way of a computer display or screen. A window in effect allows a user or operator to see an image of an application that has been constructed by the computer. For the purposes of this application, a window will be referred to as a generic view of at least a portion of a database as opposed to the term of art associated with a window. Thus, a window can be created by any computer application running any software package and can take on many forms and formats.

In many window oriented applications, the user can adjust the size of the individual windows to see either more or less of their components. For example, a window can be expanded to maximum size wherein the window fills the entire display screen. Alternatively, a window can be sized smaller than the display screen so as to permit the viewing of two or more windows. The user can scroll through information within the window through the use of a scroll bar. Scroll bars are used to facilitate quick access to large amounts of data by scrolling through the text page by page.

Databases have become widely used in business today. Databases are used to store, sort and recall massive amounts of information for display on a computer. This information needs to be displayed quickly, clearly, and accurately so it may be understood and relied upon by the user viewing the information. Information in a database is typically displayed through a window in multiple records (i.e. rows and columns) containing data fields for ease of viewing and editing. These records are typically indexed or labeled to describe and to find the information that is contained therein. An example could be a column record labeled: “Monday” and a row record labeled: “7:00 am;” thus, the information located inside of the data field where the column record and the row record intersect would be related to Monday and 7:00 am. However, in a large database with thousands of entries, the record labels may not be in close physical proximity to a data field that is being viewed, thus, the data field is not easily identifiable by a user. Currently, a user must back-track from the data field to both the column record and the row record labels to identify the information contained therein. In a large database, the task of back-tracking can be cumbersome, time consuming and cost prohibitive.

In addition, a database may contain several data fields or groups of data fields containing similar information that need to be summarized. To accomplish this task, a record containing summary information is located at a specific location in the database for viewing. Thus, all of the information located inside the data fields throughout the database or a portion of the database can be summarized in one place. However, to see the summary information, the user is typically required to scroll down, using a scroll bar, to the location of the record containing the summary information. Likewise, in a large database, the task of scrolling down to find the summary information can be cumbersome, time consuming, and cost prohibitive.

What is needed, therefore, is a method and system for displaying data fields in close proximity to accompanying information to facilitate fast and efficient understanding of the data therein.

### SUMMARY OF THE INVENTION

In general, the present invention can be described as a novel system and method for displaying data fields in close proximity to its accompanying information to facilitate fast and efficient understanding of the data therein.

In specific, the present invention can be described as a novel system and method for selectively choosing multiple variations of views for data field information and accompanying label and summary information through the use of an icon to facilitate quick and efficient viewing. This provides quick access to the accompanying label information to identify and understand the data presented.

In an exemplary embodiment of the present invention, a view displays a record with label information through a window, which is frozen in space within the window, with a plurality of data records selectably displayed through a scrolling device to view the information contained within the data fields. In this embodiment of the present invention, both the label information and the plurality of scroll ably selectable records are displayed at the same time within the window. The label information is always viewable, even when the data records are selectably scrolled, thus, the identification information for the data fields is displayed without having to search for the label.

In another exemplary embodiment of the present invention a view displays both a record with label information and a record with summary information through a window, which are frozen in space within the window, with data records truncated and selectably displayed through a scrolling device to view the information contained within the data fields. In this embodiment of the present invention, the summary information, the label information and the scroll ably selectable data records are displayed at the same time within the window. The summary information and the label information are always viewable, even when the data records are selectably scrolled, thus, the summary and identification information for the data fields are displayed without having to search for them.

In yet another exemplary embodiment of the present invention a view displays a record with label information and a record with summary information together without data records through a window. In this embodiment of the present invention, the data fields are collapsed and only the label and summary information are displayed within the window.

In another exemplary embodiment, the selectable window views can be changed from one to another through the use of a viewing icon. The viewing icon quickly and efficiently selects the viewing preference of the data fields and displays the newly selected window view on the display.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a system diagram that illustrates an exemplary environment suitable for implementing various embodiments of the present invention.

FIG. 2 is a view of a computer screen, showing a typical database through a window with data fields located thereon.

FIG. 3 is a flow chart illustrating the operation of the view mode selection aspect of the present invention.

FIG. 4 is a diagram illustrating a typical table displayed incorporating aspects of the present invention.

FIG. 5 is a diagram illustrating a typical table displayed in accordance with the truncated view mode of the present invention.

FIG. 6 is a diagram illustrating a typical table displayed in accordance with the summary view mode of the present invention.

FIG. 7 is a diagram illustrating an exemplary embodiment for providing the view mode selection icons.

### DETAILED DESCRIPTION

In general, the present invention can be described as a novel system and method for displaying data fields in close proximity to its accompanying information to facilitate fast and efficient understanding of the data therein.

Referring now to the figures, in which like numerals refer to like elements throughout the several views, exemplary embodiments of the present invention are described. Throughout the detailed description, reference will be made to the operation of the present invention when embodied within a computing device. Computing devices may include, but are not limited to, personal computers, mainframe computers, servers, and any other device capable of executing the software associated with the present invention. However, it should be understood that the features and aspects of the present invention can be ported into a variety of systems and system/network configurations and any examples provided within this description are for illustrative purposes only.

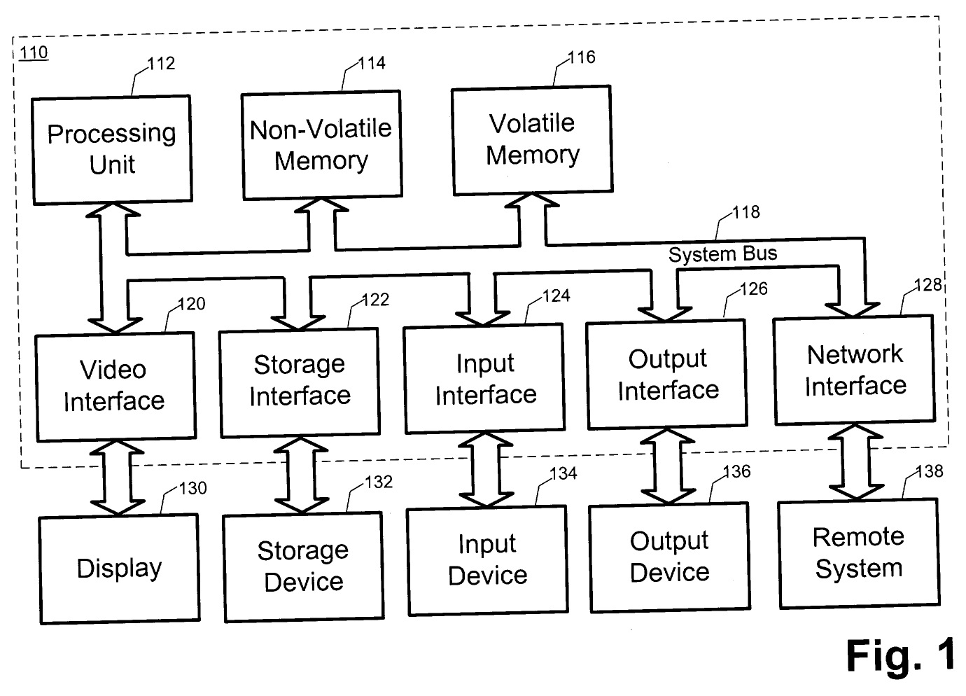

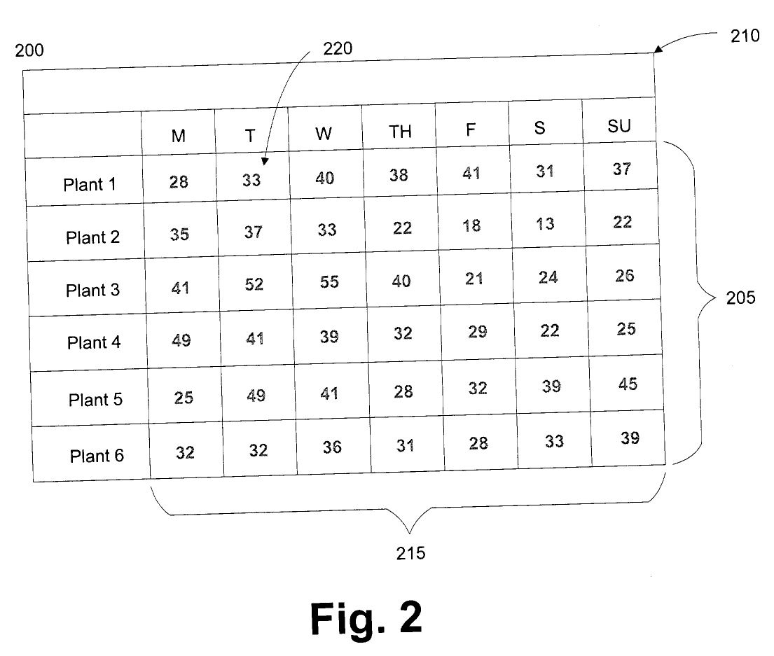

In conjunction with FIG. 1, the components of a general platform on to which aspects of the present invention can be implemented are described. Next, the operation of an exemplary embodiment of the present invention is illustrated in conjunction with FIGS. 2-7.

Exemplary Environment

FIG. 1 is a system diagram that illustrates an exemplary environment suitable for implementing various embodiments of the present invention. FIG. 1, along with the following discussion, provides a general overview of a platform onto which the invention, or portions thereof, may be integrated, implemented and/or executed. Although in the context of the exemplary environment, the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Generally, the system illustrated in FIG. 1 may be any system that includes a computer processor. Examples of such forms and functions include, but are not limited to, personal computers, hand-held devices such a personal data assistants, note-book computers, lap-top computers, mainframe computers, servers and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory and battery backed random access memory (RAM). The non-volatile memory 114 provides storage for power on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data, etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may interface with one or more storage devices such as a hard disk drive, a compact disk drive, a floppy disk drive, a RAM drive or other memory drive, for the purpose of storing information, program data or programs. The storage device 132 is accessed through a storage interface 122 that connects to the system bus 118.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may send output information, in addition to the display 130, to one or more output devices 136 such as a speaker, modem, printer, plotter, facsimile machine, RF or infrared transmitter, computer or any other of a variety of devices that can be controlled by the computing device 110. The processing unit 112 interfaces to each output device 136 through an output interface 126 coupled to the processing unit 112 over the system bus 118. The output interface 126 may include one or more of a variety of interfaces, including but not limited to, cable modems, DLS, T1, V series modems, an RS-232 serial port interface or other serial port interface, a parallel port interface, a universal serial bus (USB), a general purpose interface bus (GPIB), an optical interface such as infrared or IRDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface 124 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be stored in the non-volatile memory 114, the volatile memory 116, or in a remote memory storage device accessible through the output interface 122 and the input interface 124. The program modules may include an operating system, application programs, other program modules and program data. The processing unit 112 may access various portions of the program modules in response to the various instructions contained therein, as well as under the direction of events occurring or being received over the input interface 124.

The computing device 110 may interface with one or more remote systems 138, such as a server or client, through a network interface 128. In a networked configuration, some or all of the components of the present invention may be distributed and operate on one or more remote systems 138. The present invention may be embodied in a web application that is assessable on a remote system 138 through a browser type application running on processing unit 112.

Components of a Typical Application

FIG. 2 is a “screen shot” 200 that illustrates the operation of an exemplary embodiment of the present invention. Generally, the screen shot illustrated in FIG. 2 may be any screen that includes records of data. Examples of environments that may incorporate the this embodiment include, but are not limited to, personal computers, hand-held devices such a personal data assistants, note-book computers, lap-top computers, mainframe computers, servers and a variety of other applications, each of which may serve as an exemplary environment for embodiments of the present invention.

The screen shot 200 includes records 205 within a window 210. Each record 205 contains data fields 215. Each of the data fields 215 may contain an associated data item 220. The associated data item 220 can be text, graphics, links or any other type of data.

Operations of Exemplary Embodiments

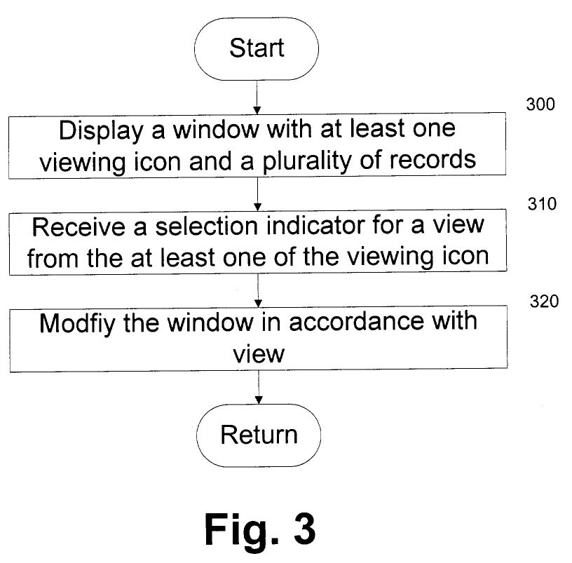

The exemplary embodiments of the present invention will now be discussed with reference to FIGS. 3-7.

In an exemplary embodiment of the present invention, a window is displayed containing label information and data records. The label information is fixed to a permanent location within the window which can include a header type position, a footer type position, column or row end positions or other locations. The data records are displayed in the window with the label information. The data records are scrollable to enable viewing of all data records in the database that may not be initially viewed on the first screen. As the data records are scrolled, the label information remains in its original location. Thus, the label information is always viewable inside of the window, even as new data records are selected to be viewed by the scroll bar.

In another exemplary embodiment of the present invention, a window is displayed containing label information, summary information and a record for containing data. Both the label information and the summary information are fixed to a permanent location within the window. The data records are displayed in the window with the label and summary information. The data records are scrollable to enable viewing of all data records in the database. As the data records are scrolled, both or either the label information and the summary information remain in their original location. Thus, the label information and summary information are always viewable inside of the window, even as new data records are selected to be viewed by the scroll bar.

In yet another exemplary embodiment of the present invention, a window is displayed containing label information and summary information. Both the label information and the summary information are fixed to a permanent location within the window. Thus, the label information and the summary information are always viewable inside of the window.

In another exemplary embodiment of the present invention, a window is displayed with a viewing icon. The viewing icon enables the selection of a viewing mode for a window. Some of the viewing modes include, but not limited to: a full view, a truncated view, and a summary view. The full view is utilized to display data records that may be associated with label information. In the full view mode, the main objective is to show as many data records as possible. Thus, the label information may default to its position relative to all of the data records and scroll along with the data records. For instance, a total line for a balance sheet may appear as the last entry in a table. If the table includes more records than that can fit on the screen, the total line may be scrolled off the screen while some of the data records are being viewed. In the truncated view mode, the main objective is to maintain a view of any label information that may be associated with data records. The label information is fixed to a permanent location within the window. The data records are displayed in the window along with the label information. For instance, a total line for a balance sheet may appear in the last entry position for the currently displayed data records. As the data records are scrolled, the total line stays in its current position. If the table includes more records than that can fit on the screen, the total line may be scrolled off the screen while some of the data records are being viewed. Similarly, a header to identify columns or rows in a table can appear in a non-scrollable fixed position. The number of data records viewable can vary from one to N where N is the total number that can be displayed given the current window size reduced by the label information areas. In the summary view mode, the main objective is to display label information. Thus, the size of the window is reduced to a size that is sufficient to display the label information but no data records. For instance, a total line for a balance sheet may be displayed in the summary view mode.

FIG. 3 is a flow chart illustrating the operation of the view mode selection aspect of the present invention. The process begins at Step 300, where a computer displays a window with at least one viewing mode icon and a data record. At Step 310, the computer receives a selection indicator that identifies a selection or actuation of a viewing mode icon. In response to receiving the selection indicator, the computer modifies the displayed window in accordance with the view mode selected at Step 320. This process can then be repeated for the selection of a new viewing mode.

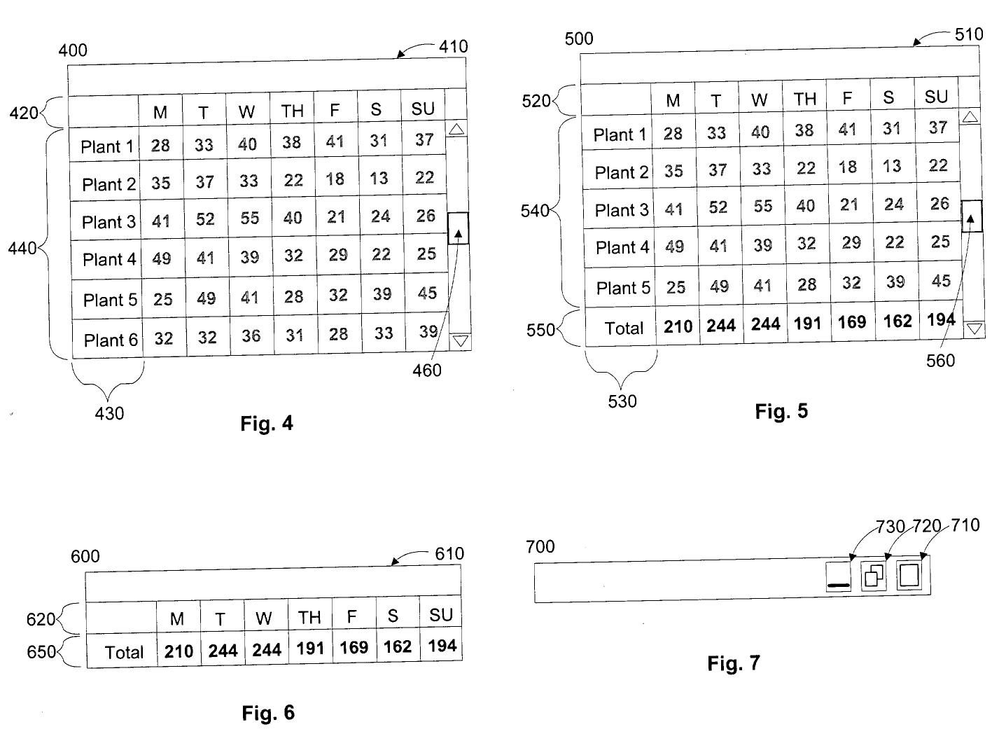

FIG. 4 is a diagram illustrating a typical displayed table depicting aspects of the present invention. The variety of views provided herein are only intended for illustrative purposes and one skilled in the art would construe them broadly and not limiting. In FIG. 4, for example, a “screen shot” 400 depicts window 410 containing row labels 430, column labels 420 and data records 440. The row labels 430 and the column labels 420 are located at a fixed location within the window 410. The plurality of data records 440 are displayed below and to the right of the row labels 430 and column labels 420. The data records 440 are not fixed to a particular location; they may be moved within the window 410 in any manner. One example of moving the plurality of records 440 within the window 410 is a scroll bar 460. The scroll bar 460 enables the data records 440 to be scrolled, thereby allowing additional data records to be viewed within the window 410. Thus, when the data records 440 are scroll ably moved, the row labels 430 and the column labels 430 remain fixed in their location for ease of identification of the data records.

FIG. 5 is a diagram illustrating a typical table displayed in accordance with the truncated view mode. In FIG. 5 a “screen shot” 500 depicts window 510 containing a row label 530, a column label 520, data records 540 and a summary label 550. The row labels 530, column labels 520 and summary label 550 are located at a fixed location within the window 510. The data records 440 are displayed below and to the right of the row labels 530 and the column labels 530 and above the summary label 550. The data records 540 are not fixed to a particular location; they may be moved within the window 510 in any manner similar to the scroll bar described in FIG. 4. Thus, when the data records 540 are scroll ably moved, the row labels 530, the column labels 520 and the summary label 550 remain fixed in their location for ease of identification and summary information of the data records.

FIG. 6 is a diagram illustrating a typical table displayed in accordance with the summary view mode. In FIG. 6 a “screen shot” 600 depicts window 610 containing column labels 620 and summary information 650. The column labels 620 and summary information 650 are located at a fixed location within the window 610. Thus, the column labels 620 and the summary information 650 remain fixed in their location for ease of identification.

FIG. 7 is a diagram illustrating an exemplary embodiment for providing the view mode selection icons. FIG. 7 illustrates an icon window 700 depicting three viewing icons: a full view icon 710, a truncated view icon 720 and a summary or collapsed view icon 730. The normal view icon 710 represents the embodiment illustrated in FIG. 4. In this mode, the label information can be fixed or can scroll with the data records. The truncated view icon 720 represents the embodiment illustrated in FIG. 5. The summary or collapsed view icon 730 represents the embodiment illustrated in FIG. 6. In an exemplary embodiment, the icon window 700 would be located at the top of any window practicing the present invention. When the normal view icon 710 is selected, the embodiment of FIG. 4 would be applied to the window. When the truncated view 720 is selected, the embodiment of FIG. 5 would be applied to the window. When the summary or collapsed view window 730 is selected, the embodiment of FIG. 6 would be applied to the window. Thus, the icon window 700 allows quick selection of the aforementioned embodiments of the present invention.

Another aspect of the present invention is the deployment of the invention within a browser environment. Through the use of frames, active-x controls, java scripts or the like, the various aspects of the present invention can be integrated onto a browser platform.

Although this disclosure describes our invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for displaying data, the method comprising the steps of:
providing the data in a first viewing mode, the first viewing mode allowing for a plurality of data records to be displayed with at least one information label associated with at least a portion of the plurality of data records; and
in response to receiving a change of viewing mode selection, modifying the display of the data to a second viewing mode, the second viewing mode allowing for a plurality of data records to be displayed with at least one information label associated with at least a portion of the plurality of data records being fixedly located within the display area immune to any scrolling activities.

2. The method of claim 1, wherein the at least one information label comprises a one or more calculated fields, the contents of which are based on one or more of the plurality of data records and the step of modifying the display of the data to a second viewing mode further comprises the step fixedly displaying the calculated fields at the lower portion of the displayed data records.

3. The method of claim 1, further comprising the step of providing a view mode selection icon associated with the second viewing mode.

4. The method of claim 1, further comprising the step of providing a plurality of mode selection icons, each of the mode selection icons being associated with a viewing mode.

5. In a browser based environment, a method for displaying tabulated data, the method comprising the steps of:
displaying the tabulated data in a default viewing mode;
providing a view mode selector that can be actuated by a selection means;
in response to detecting an actuation of the view mode selector, displaying the tabulated data in one of a variety of viewing modes comprising:
a full viewing mode, wherein a plurality of data records are displayed and full scrolling capabilities for viewing of the data records is enabled;
a truncated viewing mode, wherein at least one data record is displayed and at least one information label, associated with one or more data records, is displayed in a fixed location, and scrolling of the at least one data record will not result in moving of the at least one information label; and
a summary viewing mode wherein at least one information label, associated with one or more data records, is displayed and the information label contains information pertaining to a plurality of records.

6. The method of claim 5, wherein the providing a view mode selector step comprises providing a separate visual icon for each viewing mode.

7. A method for displaying data fields in a truncated mode on a display, the method comprising the steps of:
displaying a window on said display;
displaying at least one label record within said window fixed at a location within said window; and
displaying a plurality of data records within said window, wherein in response to receiving a scrolling request, the plurality of data records will be scrolled through but the label record will be immune to the scrolling.

8. The method of claim 7, further comprising the step of displaying a view selection icon bar, the view selection icon bar includes an icon, which when actuated by a selection device, will invoke the truncated mode display.

9. The method of claim 7, further comprising the step of displaying a view selection icon bar, the view selection icon bar including at least two icons, which when actuated by a selection device, will change the display mode of the data and, at least one of the icons will be associated with the truncated mode display.

10. The method of claim 7, wherein the label record contains identifications associated with rows of data in the plurality of data records and, the label record is fixedly attached to the left side edge of the window.

11. The method of claim 7, wherein the label record contains identifications associated with rows of data in the plurality of data records and, the label record is fixedly attached to the right side edge of the window.

12. The method of claim 7, wherein the label record contains identifications associated with columns of data in the plurality of data records and, the label record is fixedly attached to the top side edge of the window.

13. The method of claim 7, wherein the label record contains identifications associated with columns of data in the plurality of data records and, the label record is fixedly attached to the bottom side edge of the window.

14. The method of claim 7, wherein the label record contains calculated fields associated with columns of data in the plurality of data records and, the label record is fixedly attached to the bottom side edge of the window.

15. The method of claim 7, wherein the label record contains calculated fields associated with rows of data in the plurality of data records and, the label record is fixedly attached to a side edge of the window.

16. The method of claim 7, further comprising the step of displaying a view selection icon, which when actuated by a selection device, will invoke entry of the truncated mode display if a different display mode is presently active.

17. The method of claim 7, wherein the data can also be displayed in a plurality of alternate viewing modes, and further comprising the step of displaying a view mode selector, which when actuated by a selection device, will invoke one of the display modes.
